(19) United States
(12) Patent Application Publication
(10) Pub. No.: US 2011/0219422 A1
(43) Pub. Date: Sep. 8, 2011

(54) SYSTEM AND METHOD FOR DISPLAYING A DENSITY OF OBJECTS IN A SOCIAL NETWORK APPLICATION

(75) Inventors: WILLIAM SHEN, Dallas, TX (US); MARCUS HOPKINS, Desoto, TX (US); JASON D. MAIER, Frisco, TX (US); LANE ROATHE, Garland, TX (US); RICHARD RICE, Wylie, TX (US); BILLY NOLEN, Irving, TX (US); LEE ARELLANO, Addison, TX (US)

(73) Assignee: METHOD SOLUTIONS LLC, ADDISON, TX (US)

(21) Appl. No.: 12/711,096

(22) Filed: Feb. 23, 2010

Related U.S. Application Data
(60) Provisional application No. 61/154,682, filed on Feb. 23, 2009.
(60) Provisional application No. 61/245,406, filed on Sep. 24, 2009.

(51) Int. Cl. G06F 15/16; G06F 21/00

(52) U.S. Cl. 726/1; 709/204

(57) ABSTRACT

A social network application system stores profile information of one or more types of objects, such as users, places, events, things, organizations and other types of objects. The system maintains current information for the various types of objects. The current information is updated periodically. The system generates a dataset for generating density reports for one or more types of objects based on search criteria. The dataset includes current information for one or more types of objects. The dataset is transmitted to a user device. The user device displays a graphical representation of density of objects in a geographical area.

### CROSS-REFERENCE TO RELATED PATENTS

This US patent application claims priority under 35 U.S.C. §119 to a provisionally filed patent application entitled, “System and Method for a Mobile Social Network Application,” having a provisional filing date of Feb. 23, 2009, and a provisional application Ser. No. 61/154,682, and is hereby incorporated by reference.

This US patent application claims priority under 35 U.S.C. §119 to a provisionally filed patent application entitled, “System and Method for Displaying a Density of Objects in a Social Network Application,” having a provisional filing date of Oct. 24, 2009, and a provisional application Ser. No. 61/245,406, and is hereby incorporated by reference.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

1. Technical Field of the Invention

This invention relates to mobile applications and in particular to systems and methods for implementing a mobile social network application.

2. Description of Related Art

A social network application provides a website or other type of portal for users to interact with other users of the social network application. Users of the social network application create personal profiles and invite other users to be “friends” and have access to their personal profiles. Users may send messages, notifications or blog. Users may join established networks of other users in the social network application who share interests or activities. Users may update their personal profiles with user provided content, such as photos, music and videos.

Social network applications, such as Facebook™, Myspace™ and LinkedIn™, have provided people with a different and new method of communication. Social network applications are used regularly by millions of people, and it now seems that social networking will be an enduring part of everyday life.

Mobile social network applications are now being established. In mobile communities, mobile phone users can now create their own profiles, make friends, participate in chat rooms, create chat rooms, hold private conversations, share photos and videos, and share blogs by using their mobile phone. For example, one of the current wireless services for social networking in North America is Facebook™ Mobile.

With the emergence of mobile social network applications, new innovative features which extend the social networking experience into the mobile environment are needed.

### BRIEF DESCRIPTION OF THE SEVERAL VIEWS OF THE DRAWINGS

FIG. 1 illustrates a schematic block diagram of an embodiment of network systems in which a social network application system may be implemented;

FIG. 2 illustrates a schematic block diagram of an embodiment of a social network application system;

FIG. 3 illustrates a logic flow diagram of an embodiment of a method of operation of a social network application system;

FIG. 4 illustrates a logic flow diagram of an embodiment of a method of operation of a social network application system;

FIG. 5 illustrates a schematic block diagram of an embodiment of user profile data stored in a social network application system;

FIG. 6a illustrates a logic flow diagram of an embodiment of a method of operation of a social network application system;

FIG. 6b illustrates a logic flow diagram of an embodiment of a method of operation of a user device with a social network application system;

FIG. 7a illustrates a logic flow diagram of an embodiment of a method of operation of a user device with a social network application system;

FIG. 7b illustrates a logic flow diagram of an embodiment of a method of operation of a social network application system;

FIG. 8 illustrates a schematic block diagram of an embodiment of a graphical user interface displayed on a user device;

FIG. 9 illustrates a schematic block diagram of an embodiment of a graphical user interface displayed on a user device;

FIG. 10 illustrates a logic flow diagram of a method for implementing privacy policies by a social network application system;

FIG. 11 illustrates a schematic block diagram of an embodiment of types of object data stored in a social network application system;

FIG. 12 illustrates a logic flow diagram of an embodiment of a method of operation of a social network application system; and

FIG. 13 illustrates a schematic block diagram of an embodiment of object profile data stored in a social network application system.

### DETAILED DESCRIPTION OF THE INVENTION

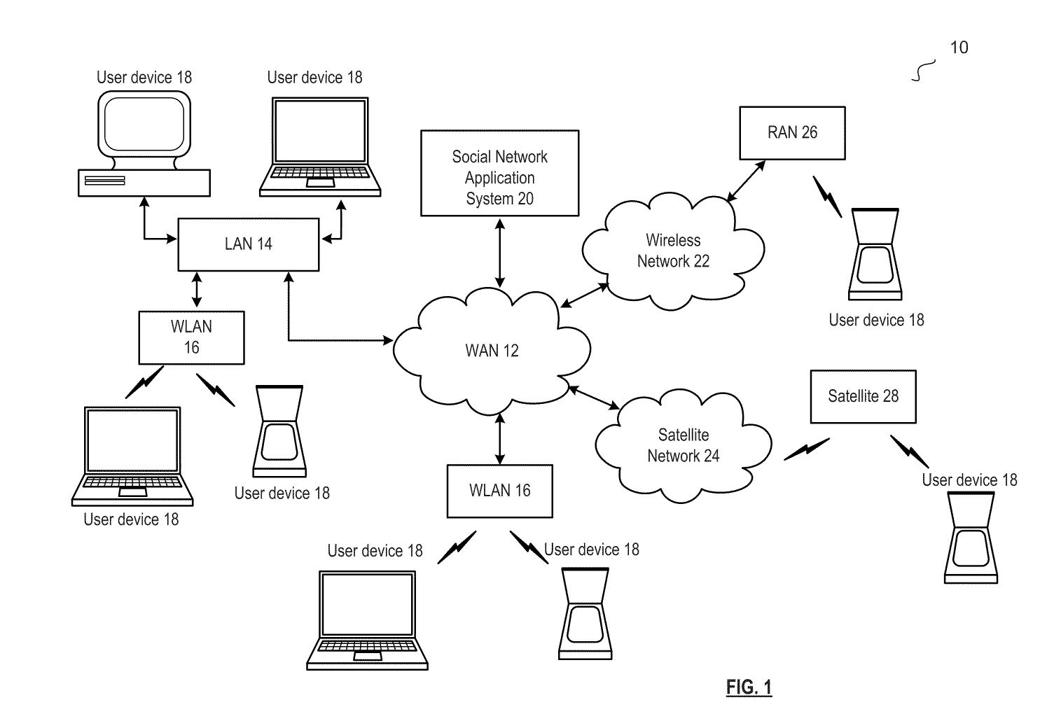

FIG. 1 is a schematic block diagram of an embodiment of network system 10 in which a social network application system 20 may be implemented. The network system 10 includes one or more networks, such as wide area network (WAN) 12, local area network (LAN) 14, wireless local area networks 16, wireless network 22 and satellite network 24 that are operable to communicate with the social network application system 20. A plurality of user devices 18 are connected to the WAN 12, the WLANs 16, wireless network 22 and satellite network 24. The user devices 18 include a personal computer, a laptop, a mobile phone, a personal digital assistant or other device operable to communicate over the WAN 12, LAN 14, WLAN 16, wireless network 22, and/or satellite network 22 with the social network application system 20. In an embodiment, one or more of the user devices 18 are mobile web-enabled devices that are able to operate in a wireless data network, such as a 3G network, EDGE network, GPRS network or WLAN network. In an embodiment, the social network application system 20 may be connected to the WAN 12 through a LAN 14 or WLAN 16 or wireless network 22.

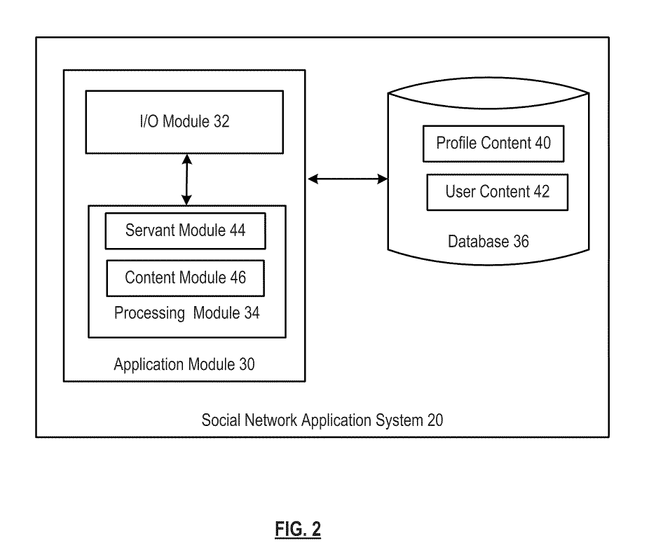

FIG. 2 is a schematic block diagram of an embodiment of a social network application system 20. The system 20 includes an application module 30 and a database 36. The application module 30 includes an interface module 32 and processing module 34. The interface module 32 is operable to interface with the plurality of user devices 18 over WAN 12, LAN 14, WLANs 16, wireless network 22 and/or satellite network 24. In an embodiment, the interface module 32 includes a network card, a web server or file server that is operable to communicate using a data transfer protocol, such as Hyper Text Transfer Protocol (HTTP) protocol, File Transfer Protocol (FTP) or other protocol designed to communicate data files, such as Hypertext Markup Language (HTML) files, text, images, audio, videos or other data files to the user devices 18. The interface module 32 may also include authentication capability that requires authentication prior to allowing access to some or all of the resources of the system 20. The interface module 32 may also include firewall, gateway and proxy server functions. The interface module 32 may include other hardware devices or software needed to provide communication between the system 20 and the user devices 18.

In an embodiment, the application module 30 also includes a processing module 34 operable to perform functions described herein. In general, the processing module 34 includes one or more processing devices, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module 34 includes a memory that is an internal memory or an external memory. The memory of the processing module 34 may each be a single memory device or a plurality of memory devices. Such a memory device may be a read-only memory, random access memory, volatile memory, non-volatile memory, static memory, dynamic memory, flash memory, cache memory, and/or any device that stores digital information. When processing module 34 may implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. Processing module 34 may execute hard coded and/or operational instructions stored by the internal memory and/or external memory to perform the steps and/or functions illustrated in FIGS. 1 through 12 described herein with respect to the social network application system 20. The processing module 34 and the interface module 32 may be integrated into one or more devices or may be separate devices.

In an embodiment, the processing module 34 includes two separate logical modules, servant module 44 and content module 46. The servant module 44 processes authentication of users, user location data and searches of profile content database 40 as explained in more detail below. The content module 46 processes static content uploaded by the user devices 18. The logical separation of the processing modules simplifies upgrades and fixes of each module. In an embodiment, the processing module 34 may be separated into additional logical modules. In another embodiment, the servant module 44 and content module 46 are combined as one logical module.

The system 20 also includes database 36. The database 36 is operable to communicate with interface module 32 and processing module 34. The database 36 may be one or more databases implemented in one or more internal memory devices, detached memory devices, network attached storage devices, storage area networks, or other memory devices located in one geographical location or multiple geographical locations. The database 36 may be structured as relational, network, hierarchal or object based or other type of structured database or document management application operable to store and locate data as described herein.

In an embodiment, the database 36 includes two logical or physical separate databases, profile content database 40 and user content database 42. The profile content database 40 includes user profile data and location information data. The user content database 42 includes data files uploaded by users to be displayed on their web pages, such as avatars, photos, videos, text, music, etc. The separation of the databases simplifies upgrades and expansion of each database. For example, the user content database 42 may be upgraded or expanded separately from the user profile database 40. In another embodiment, the profile content database 40 and user content database 42 are not separate logical databases but are combined into one logical or physical database.

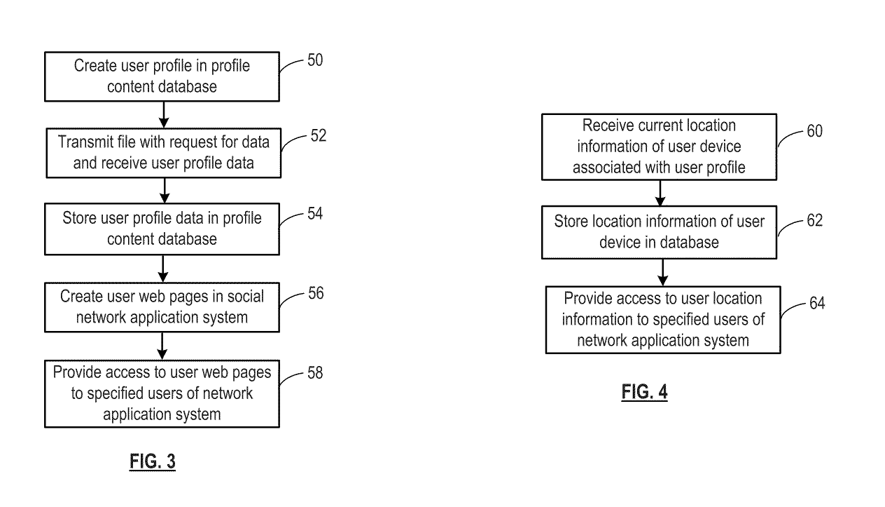

FIG. 3 illustrates a logic flow diagram of an embodiment of a method of operation of social network application system 20. In an embodiment, a user accesses the social network application system 20 with a user device 18. The user device 18 transmits a request to create a user account or profile with the system 20. The system 20 may provide free access to social networking services or charge fees. In step 50, the system 20 creates a new user account and profile in profile content database 40. The system 20 transmits one or more HTML files or other type of files requesting user profile data to the user device 18. The system 20 receives user profile data in response, in step 52. The system 20 stores the user profile data in profile content database 36 in step 54. The user profile data includes personal data and professional data, such as birthday, marital status, age, work history, education, etc. The user profile data may also include favorite objects, such as favorite books, movies, etc. In an embodiment, the user profile data also includes location data of a user device associated with the user, as explained in more detail below. The system 20 then creates one or more personalized profile documents or web pages with the user profile data in step 56. The user device 18 may transmit updates and additional data, such as text, audio files, video files, photo files, multimedia files to be added to the user's web pages. The user also specifies one or more other users of the system 20 that may access their web pages. The system 20 then provides access to the user web pages to the specified users of the system 20 in step 58.

FIG. 4 illustrates a logic flow diagram of an embodiment of another method of operation of social network application system 20. The system 20 receives current location information of a user device 18 associated with a user in step 60. In the user data profile, the user registers one or more user devices 18. The user device 18 may be a mobile device, such as a mobile phone, laptop, personal digital assistant (PDA), etc. In this case, the mobile user device 18 periodically transmits current location information to system 20. The mobile user device 18 preferably includes GPS capabilities and transmits GPS coordinates to the system 20. The location information may also be determined with triangulation techniques in wireless networks. Any other location based technology may also be used to determine the location of the mobile user device 18. Alternatively, the user device 18 may be a desktop or laptop or other type of processing device associated with a home or work or other address of the user. When a user of system 20 is at home, the user associates their location information their home address. When a user of system 20 is at work or visiting another location, the user associates their location information with the work or other address. The system 20 then stores location information for the user as their home address. When the user leaves home, the user associates their location information with a mobile user device 18. The system 20 then periodically receives updated current location information from the mobile user device 18.

In step 62 of FIG. 4, the system 20 stores the current location information of a user device 18 in profile content database 40 in an embodiment. The location information is stored as part of the user profile data. In another embodiment, the location information is stored in another presence database and associated with the user data profile. The system 20 thus maintains current location information of user devices 18 associated with users in a database.

In step 64 of FIG. 4, the system 20 provides access to current location information of a user to other specified users of the system 20. In addition, the system 20 restricts access to designated users and times. A user may designate certain times and days to publish their location information to specified users. For example, a user may specify that all friends have access to their location information on work days. But on weekends, a user may specify that only certain friends, such as relatives, be able to access their location information. The system 20 then restricts access to current location information of the user to the designated users at the specified times.

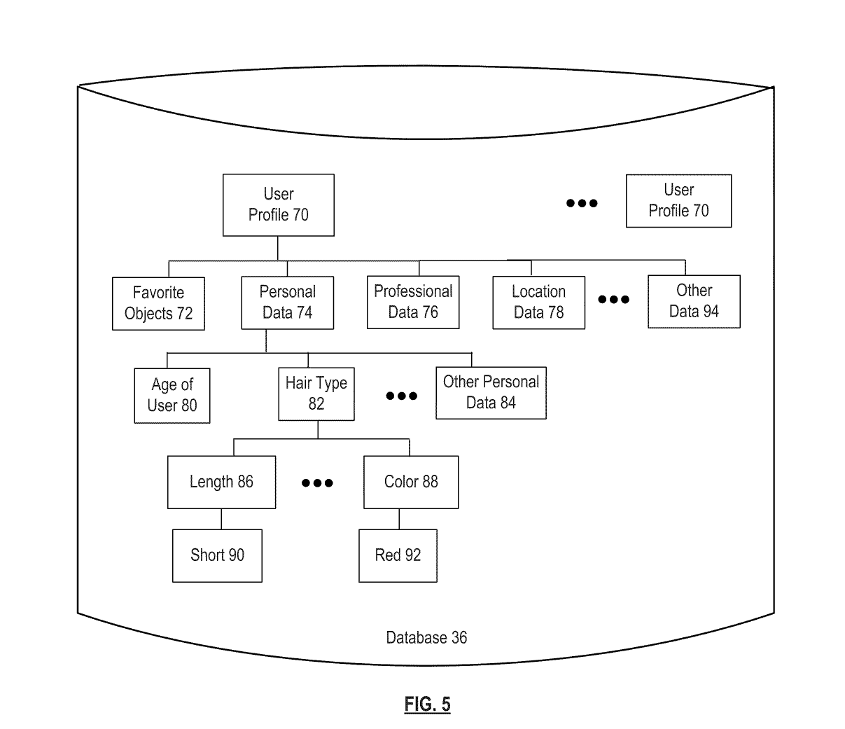

FIG. 5 illustrates a schematic block diagram of an embodiment of user profile data stored in database 36. The user profile data 70 includes personal data 74, professional data 78, favorite objects 72 and location data 78. A category or object has a branched tree of tags. The tags include the elements of information for that tag type. For example, the object of hair type 82 under personal data 74 has a branched tree of tags including length 86 and color 88. The information for tag length 86 is short 90 while the information for tag color 88 is red 92. The specific objects and tags illustrated for user profile 70 are exemplary. Other data 94 may be included in the user profile data or alternative data may be included. The user profile data 70 may be categorized in different manners with different objects and tags as well.

The system 20 thus maintains user profile data and current location information of users in database 36. With this information, the system 20 provides new innovative features to extend the social networking experience into the mobile environment.

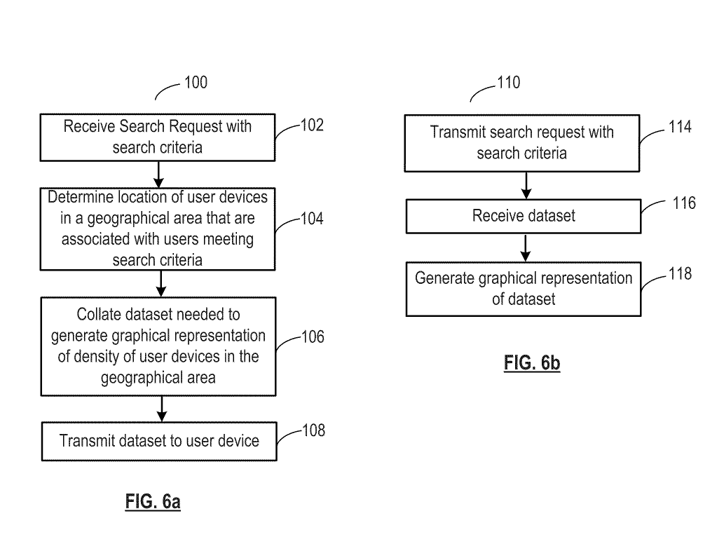

FIG. 6a illustrates an embodiment of a method for a social networking service 100 that utilizes the current location information of users to create personalized demographic reports. In step 102, the system 20 receives a request for a search having search criteria. The search criteria may include any type of data stored in the user profiles 70. The search request may include personal data, such as a specific age or age range, male or female, height, weight, hair color, etc. The search request may specify favorite criteria, such as favorite type of music, hobbies, sports, movies, books, etc. For example, search criteria may specify males, age 34 to 39 who like jazz music or females, age 40 to 44 who like to play tennis. The search request may include professional data, such as job category or school alma mater. For example, search criteria may specify attorneys, age 30 to 35. The search criteria may specify any other type of user profile data stored in user profiles 70 in database 36.

The search request also includes a geographical area. The geographical area may be designated as an address, such as an address of a nightclub or restaurant. The geographical area may be designated as part of a city or town, for example, “Uptown” or “Main Street”. The geographical area may be designated as a landmark or a city or region or state. The geographical area may be designated as a range of distance from an address or a landmark. The search criteria thus specifies a geographical area and user profile data.

In step 104 of FIG. 6a, in response to the search request, the system 20 determines current location of user devices in the geographical area that are associated with users meeting search criteria. The system 20 selects users in response to the search criteria by searching user profile data 70 in the profile content database 40. The system 20 may need to extrapolate or interpret the user profile data. For example, if the user profile data includes year of birth and the search criteria requests user with age 25 to 29, the system 20 will need to extrapolate the users with ages in the requested age range from their year of birth in the user profile data. The system 20 then determines the current location of user devices in the geographical area that are associated with the users selected in response to the search criteria.

In step 106 of FIG. 6b, the system 20 collates a dataset of quantitative data of users meeting the search criteria with a current location in the geographical area. The dataset includes information needed for a user device to generate a graphical representation of a density of users meeting the search criteria in the geographical area. In an embodiment, the dataset includes ranges of density over the geographical area. In another embodiment, the dataset may include a specific number of users. In an embodiment, for security and privacy, in general, the dataset may exclude information that could be used to identify a specific user. This policy is discussed in more detail with respect to FIG. 10. Specific user information may be provided as part of the dataset when the specific user has authorized their current location information to be provided to the requesting user. In step 108, the dataset is transmitted by the system 20 to the user device 18.

FIG. 6b illustrates an embodiment of a method of operation 110 of a user device 18. A user of the device 18 selects to perform a search. The user selects various search criteria from a graphical user interface (GUI) displayed by the device 18. The user also selects a geographical area by inputting an address or selecting an option from a GUI of a geographical area. In step 114, the user device 18 transmits the search request with the search criteria including the geographical area. In step 116, the user device 18 receives a dataset from the system 20. In response thereto, the user device 18 generates and displays the graphical representation of a density or number of user devices associated with users meeting the search criteria with a current location in the geographical area in step 118.

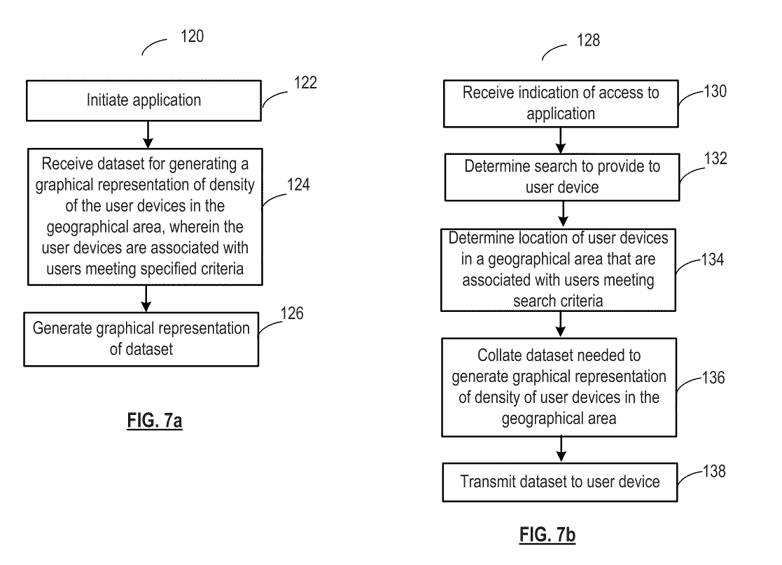

FIG. 7a illustrates another embodiment of a method of operation 110 of a user device 18. In an embodiment, the social networking service 100 pushes a dataset generated from specified search criteria predefined by a user or the social networking service to a user device 18 in response to initiation of the application. In step 122, the user device 18 initiates the application or social networking service 100, e.g. in response to user input or login authentication of the user or in response to startup of the user device 18. In step 124, the user device 18 receives a dataset for generating a graphical representation of density of user devices from the system 20. In response thereto, the user device 18 generates and displays the graphical representation of a density or number of user devices associated with users meeting a specified search criteria with a current location in the geographical area in step 118. The dataset is generated by the social networking application 100 from specified search criteria predefined by a user or the social networking service to a user device 18 in response to initiation of the application, as explained in more detail with respect to FIG. 7b.

FIG. 7b illustrates another embodiment of a method for a social networking service 100 that utilizes predefined search criteria to generate a dataset of current location information of users to create demographic reports. In step 130, the system 20 receives an indication of access to the social networking service 100 by a user device 18. The system 20 may require authentication to the application prior to allowing access. In step 132, the system 20 determines a search with predefined search criteria. The predefined criteria may include default search criteria or may include personalized predefined search criteria stored in a user profile. The predefined criteria may depend on the geographical location of the user device 18 or type of service requested by a user. In response to the determined search, the system 20 determines current location of user devices in a geographical area meeting the predefined search criteria in step 134. In step 136, the system 20 collates a dataset of quantitative data of users with a current location in a geographical area and meeting the predefined search criteria. In step 138, the system transmits the dataset to the user device 18.

For example, in response to initiation (and authentication if required) of any user device 18, the system 20 may generate and push a dataset from a search with default search criteria of all active users in the geographical area of a current location of the user device 18. In another example, a store owner may define a search with search criteria of active users in a geographical area of a shopping mall. The search is stored in the user profile for the store owner. A dataset for the predefined search is automatically pushed to a user device 18 associated with the store owner upon initiation of the application and at defined periods thereafter.

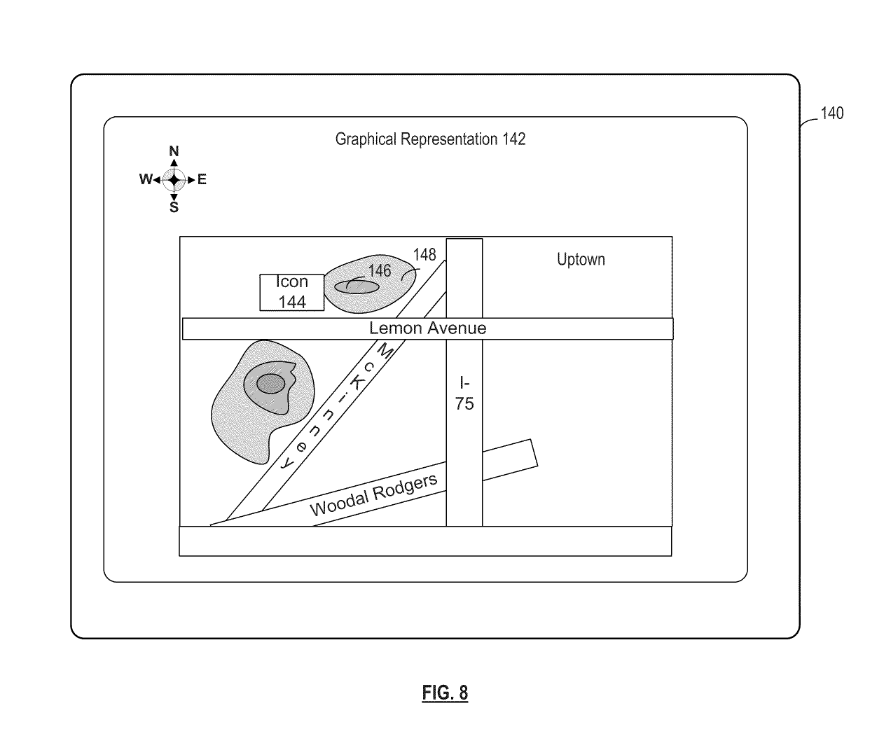

FIG. 8 illustrates a schematic block diagram of an embodiment of a display 140 from the user device 18. The display 140 of the user device 18 illustrates a graphical representation 142 of a density of user devices associated with users that meet the search criteria and have a current location in the geographical area. In an embodiment, the graphical representation 142 is a heat map. The heat map provides a geographical representation of the density of user devices represented as colors or shading. The density indicates the number of individuals per unit of area. For example, in FIG. 8, the darker shaded area 146 indicates an increased density of user devices in that area from the lower shaded area 148. The heat map may also include one or more icons 144 that provide more detailed information about the relative number of users when selected. For example, when icon 144 is selected, it may illustrate the range of numbers or a specific number of users per each shaded area. It may also indicate any friends and their current location when the requesting user is authorized to access this information. The geographical representation may be a two dimensional or three dimensional map.

A heat map is one embodiment of the graphical representation of density of users in a geographical area. Other types of GUIs may also be used. For example, in another embodiment, a graph illustrates the density in a geographical area. When the geographical area is a specific location or address, such as an address of a restaurant, the graphical representation may include a number or a range of numbers of users at the location rather than a density. Thus, the graphical representation is any type of GUI that conveys a density or number of users with a current location in the geographical area.

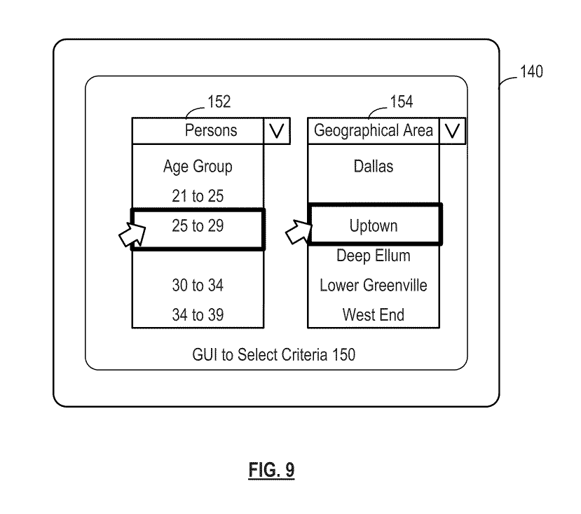

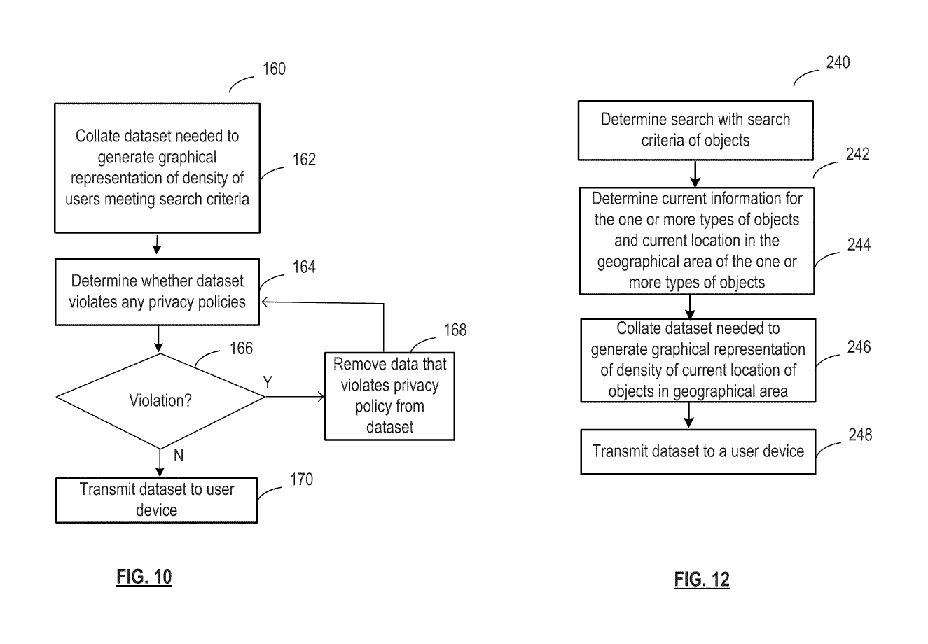

FIG. 9 illustrates a schematic block diagram of an embodiment of a display 140 from the user device 18. When a user of a device 18 selects to perform a search, the user device 18 displays a GUI 150 of search criteria. For example, in FIG. 9, the GUI 150 displays search criteria for various age groups 152. The user then selects the desired age group 152 from the GUI 150. In another embodiment, GUI 150 provides an option to input specific criteria rather than selecting from a list. The user also selects a geographical area for the search. The GUI 150 provides a list of locations 154. In another embodiment, GUI 150 provides an option to input a specific address or geographical area.

In order to protect privacy of users, the system 20 implements various privacy policies restricting information provided in response to a search request. For example, the system 20 provides quantitative data in response to a search request without identification of specific users. Another privacy policy relates to a number of users that will be reported in a small geographical area. The system 20 will not report a low number of users meeting specified criteria in a small geographical area such that a particular user could be identified or located. When the density of users in a geographical area is below a threshold number, the system 20 will remove the information for those users. For example, if the search criteria requests females, age 24 to 29, with long, blonde hair at a specific address, the system 20 will not respond when only 1 user meets that criteria. If the density of users at the specific address is 30, then the system 20 may respond with the information. The threshold number depends on the geographical area and type of criteria. For a specific address, the threshold number of users will be high. For large geographical areas, the threshold number may be lower. When the search criteria specifies males who play tennis age 24 to 29 with blonde hair in the city of Dallas, the system 20 may report that five or less users within Dallas meet the criteria since it would be difficult to identify or locate a specific user in such a large area.

FIG. 10 illustrates a logic flow diagram of a method 160 for implementing privacy policies by the system 20. In response to receiving a search request, the system 20 collates a dataset to generate a graphical representation of density of users in response to the search criteria. The system 20 in step 164 evaluates the dataset to determine whether it violates any privacy policies. When there is a violation in step 166, the system 20 removes select data from the dataset that violates the privacy policy. The system 20 then determines whether the dataset still violates a privacy policy in step 164. When the dataset does not violate a privacy policy, the system 20 transmits the dataset to a user device in step 170. In addition to user profile data 70 in database 36, in an embodiment, the system 20 maintains profiles of other objects, such as events, places, organizations, things, etc.

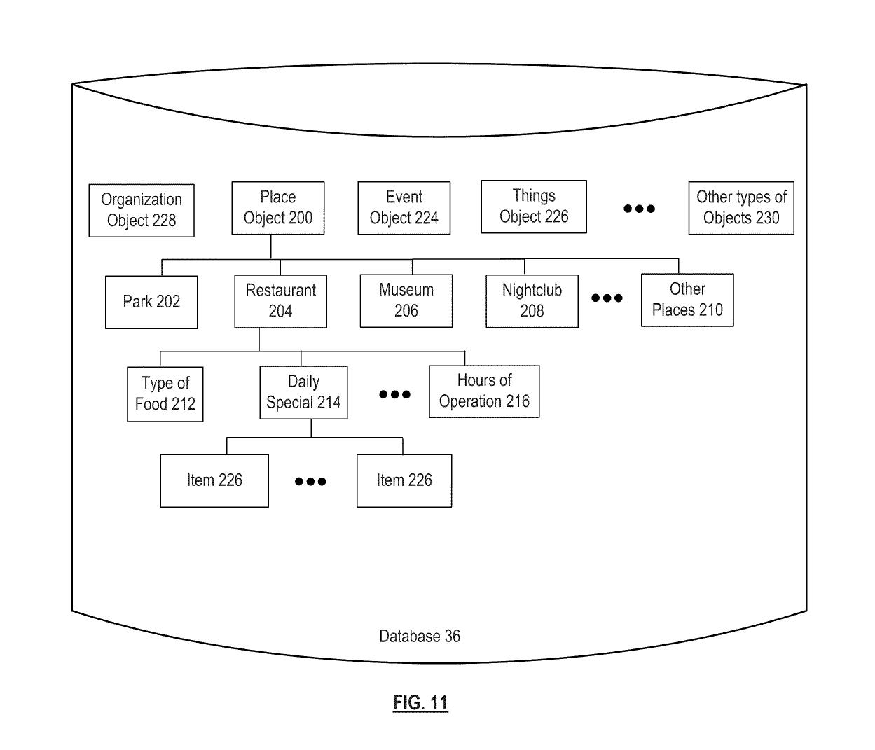

FIG. 11 illustrates database 36 with profiles of various exemplary objects, including place object 200, event object 224, things object 226, organization objects 228 and other types of objects 230. Each object has a branched tree of objects and tags. The tags include information for that tag type. For example, the place object 200 has a branched tree for various object types, such as park 202, restaurant 204, museum 206, nightclub 208 and other types of places 210. The restaurant object 204 includes a branched tree of other object types, including type of food 212, daily specials 214 and hours of operation 216. The daily special object 214 includes tag types for each item 226. Organization object 228 may include schools, music bands, non-profit groups, book clubs, companies, etc. Object for things 226 may include books, movies, games, etc. Event objects 224 may include concerts, plays, etc.

The system 20 maintains current information for each type of object. The system 20 receives periodic updates to the current information in the profiles. The updates may be daily, hourly or up to the minute. For example, a restaurant may update its food specials on a daily basis. A movie theater may update which movies are sold out and which still have available tickets and show times on an hourly basis. A nightclub may provide updates of a current song being played on the dance floor every few minutes. The system 20 maintains the current information for the various types of objects in database 36.

FIG. 12 illustrates a logic flow diagram of an embodiment of a social networking service 240 utilizing current information for various types of objects to create personalized density reports. Similarly to density of users, the system 20 generates quantitative data on density of various types of objects, such as places, events, organizations, user profiles or a combination thereof. In step 242, the system 20 determines a search for a density report with search criteria of one or more types of objects. As discussed previously, the determined search may be generated in response to a search criteria received from a user device 18. In an embodiment, the search may be predefined by a user or a default search with predefined search criteria. The search criteria may include current information of the objects that is updated periodically. As discussed above, for user profile data, the current information includes current location information of user devices. For an organization, such as a book club, the current information may include a book being reviewed at the next meeting. For a restaurant, the current information may include the menu specials of the day. For an event, such as a football game, the current information may include the parking lots with available spaces.

In step 244, the system 20 determines objects in response to the search criteria. The system 20 searches the database 36 for particular objects meeting the search criteria. For example, when the search criteria includes bars currently having happy hour drink specials, the system 20 searches location objects corresponding to bars with a current information including a happy hour. The search request may include criteria relating to more than one type of object. For example, the search criteria may include a request for bars currently having happy hour drink specials and density of males 30 to 34.

In step 246, the system 20 collates a dataset for generating a graphical representation of objects in a geographical area in response to the search criteria. In an embodiment, the dataset is based on current information of one or more types of objects. For example, in response to the request for bars currently having happy hour drink specials and density of males 30 to 34, the system 20 searches location objects corresponding to bars with a current information including a happy hour and searches user profile data to determine a current information of location of men age 30 to 34 at the bars. The system 20 collates the data from the searches and generates a dataset for generating a graphical representation of the objects selected in response to the search criteria.

In step 248, the system 20 transmits the dataset to the user device 18. The user device 18 utilizes the dataset to generate a map of the geographical area having a graphical representation of one or more types of objects meeting the search criteria. For certain types of objects, the graphical representation may be specific, such as location of the bars having happy hour. However, for demographic data based on user profile data, the system 20 only provides quantitative data of density.

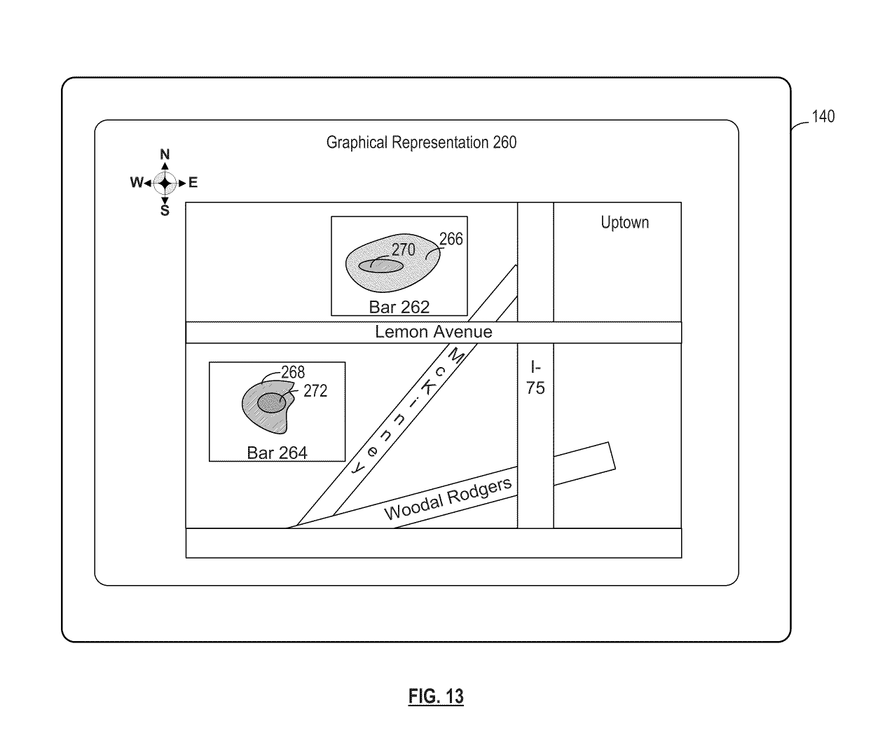

FIG. 13 illustrates a schematic block diagram of an embodiment of a display 140 from the user device 18. The display 140 of the user device 18 illustrates an exemplary graphical representation 260 of one or more types of objects meeting the search criteria. The graphical representation 260 is in response to search criteria including a request for bars currently having happy hour drink specials and density of males 30 to 34. The graphical representation 260 includes location of two bars, bar 262 and bar 264, having current information of a happy hour. The graphical representation 260 also includes a density of user devices 18 associated with users that meet the search criteria of males, age 30 to 34 and have a current location in the bars 262 and 264. In an embodiment, the graphical representation 260 is a heat map. The heat map provides a two-dimensional map of the geographical area with the density of user devices represented as colors or shading. The density indicates the number of individuals per unit of area. The density of user devices is represented in FIG. 13 as lighter shaded areas 266 and 268 and darker shaded areas 270 and 272. The heat map may also include one or more icons that provide more detailed information about the objects. For example, when selected, the icons may provide address information for the bars 262 and 264.

The system 20 provides new applications that extend the social networking experience into the mobile environment. The system 20 stores profile information of one or more types of objects, such as users, places, events, things, organizations and other types of objects. The system 20 maintains current information for the various types of objects. The current information is updated periodically. For users, the system 20 maintains current location of user devices associated with the user profiles. The system 20 generates a dataset for generating density reports with one or more types of objects based on search criteria. The dataset includes current information for one or more types of objects. The dataset is transmitted to a user device. The user device displays a graphical representation of density of objects in a geographical area based on current information.

As may be used herein, the term “operable to” indicates that an item includes one or more of processing modules, data, input(s), output(s), etc., to perform one or more of the described or necessary corresponding functions and may further include inferred coupling to one or more other items to perform the described or necessary corresponding functions.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by one or multiple discrete components, networks, systems, databases or processing modules executing appropriate software and the like or any combination thereof.

What is claimed is:

1. A method for a social networking application system, comprising:
determining current location of user devices in a geographical area, wherein the user devices are associated with users meeting specified criteria;
collating a dataset for generating a graphical representation of density of the user devices in the geographical area; and
transmitting the dataset to a user device.

2. The method of claim 1, further comprising:
receiving a search request from a user device for a demographic report having search criteria.

3. The method of claim 1, further comprising:
in response to access of a user device to the social networking application system, determining specified search criteria predefined by a user associated with the user device.

4. The method of claim 1, further comprising:
in response to access of a user device to the social networking application system, determining specified search criteria predefined by the social networking application for the user device.

5. The method of claim 1, comprising:
receiving current location information of user devices associated with users of the social networking application;
storing the current location information of user devices in a database; and
accessing the current location information of user devices in the database when determining location of user devices in the geographical area.

6. The method of claim 5, comprising:
storing user profile data in the database for users of the social networking application.

7. The method of claim 6, comprising:
providing a graphical user interface (GUI) to a user device for generating a search request, wherein the GUI includes options for selecting search criteria for the demographic report.

8. The method of claim 7, wherein the search criteria for the demographic report includes types of data of the user profile data.

9. The method of claim 1, wherein the graphical representation of density of the user devices in the geographical area is a heat map.

10. The method of claim 1, wherein the graphical representation of density of the user devices in the geographical area is a graph.

11. The method of claim 1, further comprising:
determining whether the dataset violates a privacy policy; and
when the dataset violates the privacy policy, removing data from the dataset that violates the privacy policy.

12. A social networking application system, comprising:
one or more databases for storing user profiles for users of the social networking application and for storing a current location information of user devices associated with the users;
one or more processing modules operable to:
receive a search request for a demographic report having search criteria, wherein the search criteria specifies a geographical area and user profile data;
determine location of user devices in the geographical area, wherein the user devices are associated with users meeting the search criteria;
collate a dataset for generating a graphical representation of density of the user devices in the geographical area; and
transmit the dataset to a user device.

13. The social networking application system of claim 12, wherein the one or more processing modules are further operable to:
receive current location information from user devices associated with the users of the social networking application; and
access the current location information of user devices in the database when determining location of user devices in the geographical area.

14. The social networking application system of claim 13, wherein the one or more processing modules are further operable to:
provide a graphical user interface (GUI) to a user device for generating a search request, wherein the GUI includes options for selecting search criteria for the demographic report.

15. The social networking application system of claim 14, wherein the graphical representation of density of the user devices in the geographical area comprises a heat map, wherein the heat map provides a map of the geographical area with the density of the user devices represented as different shades of color.

16. The social networking application system of claim 12, wherein the one or more processing modules are further operable to:
determine whether the dataset violates a privacy policy; and
when the dataset violates the privacy policy, remove data from the dataset that violates the privacy policy.

17. A method for a social networking application system, comprising:
determining a search request by the system having search criteria, wherein the search criteria specifies a geographical area and one or more types of objects;
in response to the search criteria, determining current information for the one or more types of objects and current location in the geographical area of the one or more types of objects;
collating by a processing module in the system a dataset for generating a graphical representation of density of the one or more types of objects in the geographical area; and
transmitting the dataset to a user device.

18. The method of claim 17, comprising:
receiving current information for the one or more types of objects, wherein the types of objects include at least one of: places, events, organizations and users;
storing the current information in profiles stored in the database for the one or more types of objects; and
accessing the current information in the database by the processing module for the one or more types of objects.
